(19) United States
(12) Patent Application Publication
(10) Pub. No.: US 2004/0080547 A1
(43) Pub. Date: Apr. 29, 2004

(54) Input unit and allocation method of menu item for use in input unit

(75) Inventor: Tetsuya Goto, Fuji-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/279,115

(22) Filed: Oct. 24, 2002

(51) Int. Cl. G09G 5/00

(52) U.S. Cl. 345/827

(57) ABSTRACT

An input unit has a first memory section in which various types of menu items for carrying out operation start, setting, and key allocation of respective functions are set, and selects and operates one of a plurality of keys to be set in which the various menu items can be set as key functions, in a state in which a menu item of key allocation is displayed on a display by a key for reading. Then, by reading a menu item for which allocation is desired from the first memory section by the key for reading, the input device allocates the menu item to the one of the keys to be set.

### BACKGROUND OF THE INVENTION

1. Field of the Invention

The present invention relates to an input unit comprising various types of keys and a display, and to an allocation method of menu items for use in the input unit.

2. Description of the Related Art

As a recent business machine, a business machine in which a plurality of functions are integrated in one machine, and which is called a multifunction product in particular, has been known. In such a business machine, various types of functions must be appropriately operated so as to suit the desires and the environment of a user.

In these business machines, an operation panel on which a display and a plurality of key buttons are disposed is provided as an input unit. For example, when the business machine is connected to a telephone line, some of the key buttons are allocated as short-cut keys for simply reading specific functions of the business machine and enabling them to work, or as one-touch keys for one-touch dialing to other parties of telephone numbers which have been set.

It is the manufacturer who allocates some of the key buttons to the short-cut keys. Some of the key buttons are allocated to the short-cut keys such that functions, which the manufacturer has predicted will be frequently accessed, can be simply read.

However, there are cases in which the functions which the manufacturer has predicted will be frequently accessed are rarely accessed by a specific user. In such cases, there is a desire for the user to allocate other functions to the short-cut keys. However, at present, the short-cut keys once allocated by the manufacturer cannot be changed by the user.

### BRIEF SUMMARY OF THE INVENTION

In an input unit, it has been desired that the short-cut keys once allocated by the manufacturer can be easily changed.

According to an aspect of the invention, various types of menu items for carrying out operation start, setting, and key allocation of each function are set in a first memory section. Further, a plurality of keys to be set, at which the various types of menu items set in the first memory section can be set as key functions, are provided.

The various types of menu items set in the aforementioned first memory section are successively read by keys for reading and are displayed on a display. In this state, one of the keys to be set is selected and operated, and by reading a menu item for which allocation is desired from the first memory section by the keys for reading, the menu item is allocated to the one of the keys to be set. Then, the menu items allocated to the respective keys to be set are respectively stored in a second memory section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate a embodiments of the invention, and together with the general description given above and the detailed description of the embodiments given below, serve to explain the principles of the invention.

FIG. 1 is a block diagram showing a configuration of a multifunction product in an embodiment of the present invention.

FIG. 2 is a diagram showing a panel configuration of an operating section in the embodiment.

FIG. 3 is a diagram showing stored contents of a first memory section in the embodiment.

FIG. 4 is a diagram showing stored contents of a second memory section in the embodiment.

FIG. 5 is a diagram showing a procedure of reading items by a menu key, a NEXT key, and a set key provided at the operating section in the embodiment.

FIG. 6 is a flowchart showing a key allocation processing carried out by a CPU in the embodiment.

FIG. 7 is a diagram showing stored contents of the second memory section after changing of the key allocation in the embodiment.

FIG. 8 is a diagram showing a panel configuration of the operating section after changing of the key allocation in the embodiment.

FIG. 9 is a flowchart showing a processing of changing the menu order carried out by the CPU in the embodiment.

FIG. 10 is a diagram showing stored contents of the first memory section after changing of the menu order in the embodiment.

FIG. 11 is a diagram showing a procedure of reading items after changing of the menu order, by the menu key, the NEXT key, and the set key provided at the operating section in the embodiment.

### DETAILED DESCRIPTION OF THE INVENTION

An embodiment of the present invention will be described with reference to the drawings.

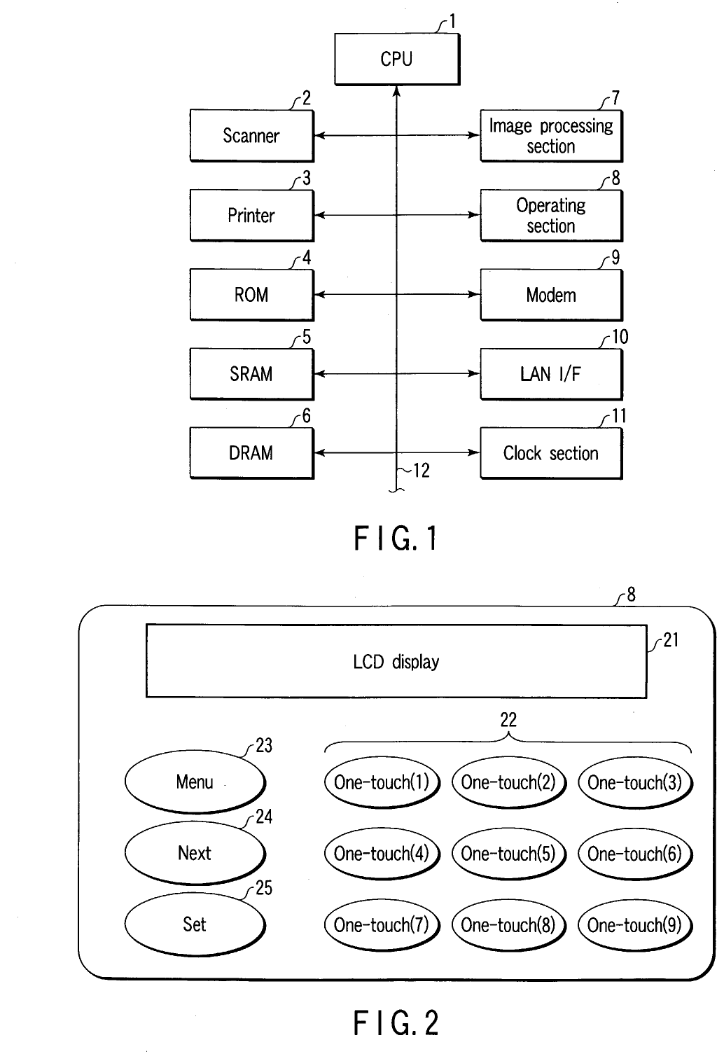

FIG. 1 is a block diagram showing a configuration of, for example, a multifunction product. A CPU (central processing unit) 1 constitutes a control section main body and carries out system control. A scanner 2 comprises, for example, a CCD (charge coupled device), and reads an original to be set and converts it into image data and outputs the data.

A printer 3 is a page printer for printing out image data or text data in units of pages. A ROM (read only memory) 4 includes a part of a flash ROM, and stores program data by which the CPU 1 controls respective sections, or program data for executing communication processes.

An SRAM (static random access memory) 5 constitutes a first memory section in which various types of menu items for carrying out operation start, setting, and key allocation of respective functions are set, and a second memory section in which the menu items allocated to the respective keys to be set are respectively stored, a memory section for storing telephone numbers, and the like.

A DRAM (dynamic random access memory) 6 constitutes a memory section in which a page buffer or image data used by the printer 3 are temporarily stored, and the like. An image processing section 7 carries out processing of encoding and decoding of image data.

An operating section 8 configures an input unit. As shown in FIG. 2, an LCD (liquid crystal display) 21, nine one-touch keys 22 serving as keys to be set, and a menu key 23, a NEXT key 24, and a set key 25 serving as keys for reading which successively read the various types of menu items set in the first memory and display them on the LCD 21, are disposed at the operating section 8.

A modem 9 has both a high-speed and low-speed modem function for sending and receiving facsimile signals or the like, and a data communication modem function for carrying out communication with a provider. A LAN interface 10 is connected to a digital line such as a LAN or the like, and carries out sending and receiving of digital data. A clock section 11 clocks the date and time.

The CPU 1 and the scanner 2, printer 3, ROM 4, SRAM 5, DRAM 6, image processing section 7, operating section 8, modem 9, LAN interface 10, and clock section 11 are electrically connected to one another by a bus line 12.

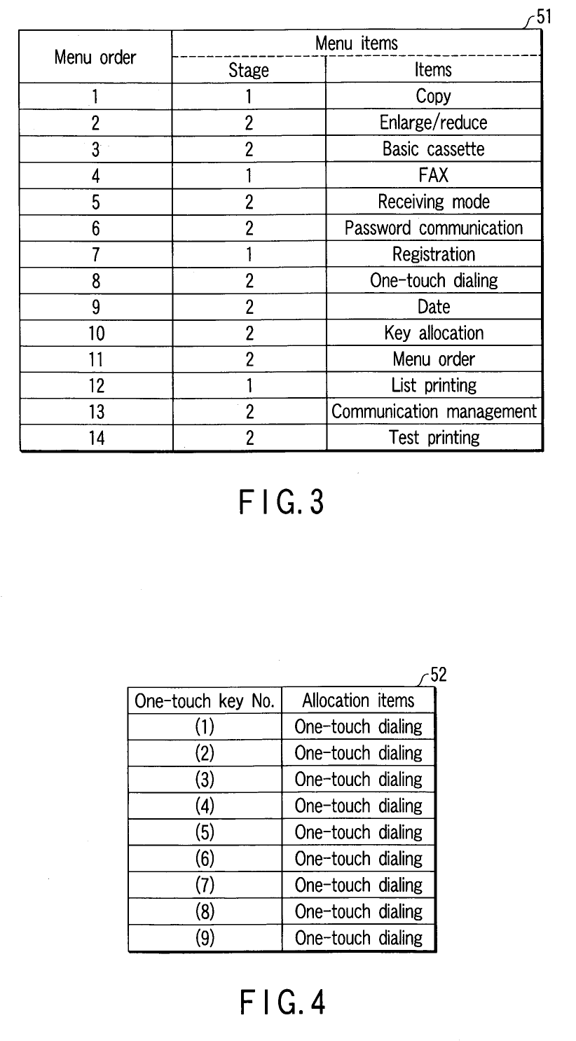

As shown in FIG. 3, 14 types of menu items denoted by menu orders 1 to 14 are set in a first memory section 51 of the SRAM 5.

The menu items are classified into two stages. As first stage menus, there are respective items of copy, FAX (facsimile), registration, and list printing. Further, as second stage menus, there are two items of enlarge/reduce and basic cassette beneath copy, and there are two items of receiving mode and password communication beneath FAX, and there are four items of one-touch dialing, date, key allocation, and menu order beneath registration, and there are two items of communication management and test printing beneath list printing.

Copy, enlarge/reduce, basic cassette, FAX, receiving mode, password communication, registration, one-touch dialing, date, key allocation, menu order, list printing, communication management, and test printing are set in the first memory section 51 in accordance with the menu orders 1 to 14.

As shown in FIG. 4, items respectively allocated to the nine one-touch keys 22 denoted by one-touch numbers from (1) to (9) are set in a second memory section 52 of the SRAM 5.

Items allocating a one-touch dialing function to all of the respective one-touch keys 22 are set in the second memory section 52.

The nine one-touch keys 22 correspond one-to-one to telephone numbers set in advance in the memory. A corresponding telephone number is read from the corresponding memory section by operation of the one-touch key 22, and a telephone call is made to another party.

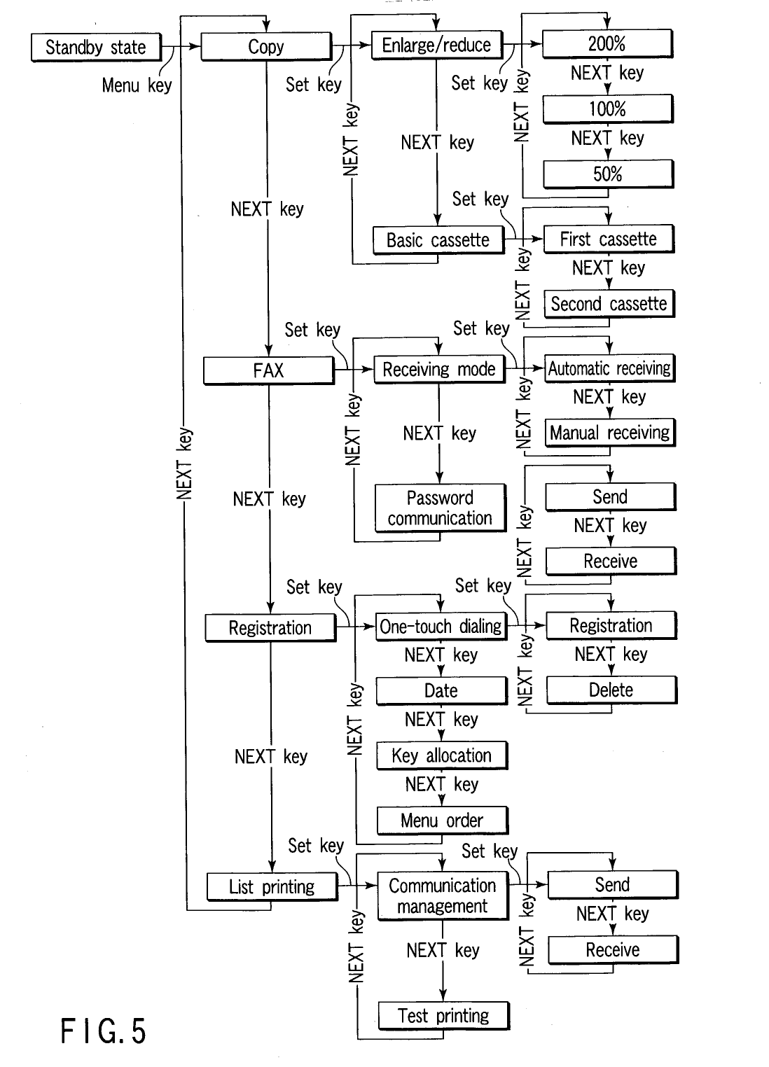

FIG. 5 shows relationships between operations of the menu key 23, the NEXT key 24, and the set key 25 of the operating section 8, and items which are read from the first memory section 51 at the time of operation and displayed on the display 21.

That is, when the menu key 23 is operated in a standby state, in accordance with the menu order, first, the item of copy is read from the first memory section 51 and displayed on the display 21.

When the NEXT key 24 is operated in this state, the item of FAX which is the next first stage menu is read from the first memory section 51, and displayed on the display 21.

When the NEXT key 24 is further operated in this state, the item of registration which is the next first stage menu is read from the first memory section 51, and displayed on the display 21.

Furthermore, when the NEXT key 24 is operated in this state, the item of list printing which is the next first stage menu is read from the first memory section 51, and displayed on the display 21.

Moreover, when the NEXT key 24 is operated in this state, again, the item of copy is read from the first memory section 51 and displayed on the display 21.

In this way, by repeating operation of the NEXT key 24, the respective items of copy, FAX, registration, and list printing are successively and repeatedly read and displayed on the display 21.

In addition, when the set key 25 is operated in a state in which the item of copy is read and displayed on the display 21, the item of enlarge/reduce which is a second stage menu is read from the first memory section 51 and displayed on the display 21.

When the NEXT key 24 is operated in this state, the item of basic cassette which similarly is a second stage menu is read from the first memory section 51, and displayed on the display 21.

In this way, by repeating operation of the NEXT key 24, the item of enlarge/reduce and the item of basic cassette are alternately read.

When the set key 25 is operated in a state in which the item of enlarge/reduce is read and displayed on the display 21, 200% is displayed on the display 21. When the NEXT key 24 is operated in this state, the display is switched from 200% to 100%. Then, when operation of the NEXT key 24 is further repeated, the display is changed in a manner such as 100%→50%→200%→100%.

This shows that the enlargement/reduction of the copy is switched among the three stages of 200%, 100%, and 50%.

Further, when the set key 25 is operated in a state in which the item of basic cassette is read and displayed on the display 21, a first cassette is displayed on the display 21.

When the NEXT key 24 is operated in this state, the display is switched from the first cassette to a second cassette. Operation of the NEXT key 24 is repeated further, and then the display is changed in a manner such as second cassette → first cassette → second cassette.

This shows that it is selected whether the basic cassette in which papers to be used for copying are accommodated is to be the first cassette or the second cassette.

Further, when the set key 25 is operated in a state in which the item of FAX is read and displayed on the display 21, the item of receiving mode which is a second stage menu is read from the first memory section 51, and displayed on the display 21.

When the NEXT key 24 is operated in this state, the item of password communication, which similarly is a second stage menu, is read from the first memory section 51, and displayed on the display 21. By repeating operation of the NEXT key 24, the item of receiving mode and the item of password communication are alternately read.

When the set key 25 is operated in a state in which the item of receiving mode is read and displayed on the display 21, automatic receiving is displayed on the display 21.

When the NEXT key 24 is operated in this state, the display is switched from automatic receiving to manual receiving.

This shows that it is selected whether the receiving mode of FAX is to be automatic receiving or manual receiving.

Moreover, when the set key 25 is operated in a state in which the item of password communication is read and displayed on the display 21, send is displayed on the display 21.

When the NEXT key 24 is operated in this state, the display is switched from send to receive.

This shows that it is selected whether the password communication of FAX is to be send or receive.

Further, when the set key 25 is operated in a state in which the item of registration is read and displayed on the display 21, the item of one-touch dialing which is a second stage menu is read from the first memory section 51, and displayed on the display 21.

When the NEXT key 24 is operated in this state, the item of date, which similarly is a second stage menu, is read from the first memory section 51, and displayed on the display 21.

When the NEXT key 24 is operated further in this state, the item of key allocation, which similarly is a second stage menu, is read from the first memory section 51, and displayed on the display 21.

When the NEXT key 24 is operated further in this state, the item of menu order, which similarly is a second stage menu, is read from the first memory section 51, and displayed on the display 21.

When the NEXT key 24 is operated further in this state, the item of one-touch dialing, is again read from the first memory section 51, and displayed on the display 21.

In this way, by repeating operation of the NEXT key 24, the respective items of one-touch dialing, date, key allocation, and menu order are successively and repeatedly read, and displayed on the display 21.

When the set key 25 is operated in a state in which the item of one-touch dialing is read and displayed on the display 21, registration is displayed on the display 21.

When the NEXT key 24 is operated in this state, the display is switched from registration to delete.

This shows that it is selected whether the one-touch dialing is to be registration or delete.

Further, when the set key 25 is operated in a state in which the item of list printing is read and displayed on the display 21, the item of communication management which is a second stage menu is read from the first memory section 51, and displayed on the display 21.

When the NEXT key 24 is operated in this state, the item of test printing, which similarly is a second stage menu, is read from the first memory section 51, and displayed on the display 21. Then, by repeating operation of the NEXT key 24, the item of communication management and the item of test printing are alternately read.

When the set key 25 is operated in a state in which the item of communication management is read and displayed on the display 21, send is displayed on the display 21.

When the NEXT key 24 is operated in this state, the display is switched from send to receive.

This shows that it is selected whether the communication management is to be send or receive.

The operating section 8 can reset the nine one-touch keys 22, in which telephone numbers of other parties for one-touch telephoning are registered, to other functions, and can make the nine one-touch keys 22 function as short-cut keys.

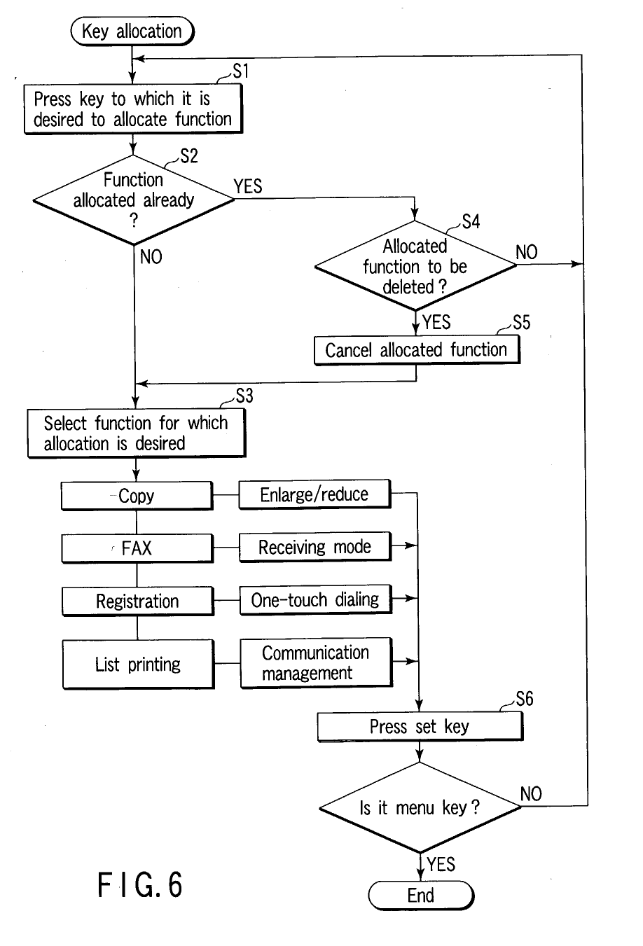

By operating the menu key 23, the NEXT key 24, and the set key 25, the item of key allocation is read from the first memory section 51, and displayed on the display 21. In this state, the CPU 1 carries out the key allocation processing shown in FIG. 6.

First, in S1, a key to which it is desired to allocate a function is pressed. Next, in S2, it is determined whether or not a function has already been allocated to the pressed key. If the function is not allocated to the pressed key, the function for which allocation is desired is selected in S3.

Further, if a function has been allocated to the pressed key, subsequently, it is determined whether the allocated function is to be released in S4. In a case that the allocated function is to be released, the allocated function is cancelled in S5, and the function for which allocation is desired is selected in S3.

Alternatively, in a case in which the allocated function is not to be released, the routine returns to the first stage.

The operation, in which the function for which allocation is desired is selected in S3, is an operation in which any of copy, fax, registration, and list printing is selected by operating the menu key 23, the NEXT key 24, and the set key 25, and a second stage menu is further selected.

For example, when the item of enlarge/reduce is to be allocated to the one-touch key 22 of key No. (1), after the one-touch key 22 of Key No. (1) is pressed as a key to which it is desired to allocate a function, the item of copy which is a first stage menu is selected. Moreover, operation of selecting the item of enlarge/reduce which is a second stage menu is carried out. Thereafter, in S6, the set key 25 is operated.

In the same way, when the item of basic cassette is to be allocated to the one-touch key 22 of key No. (2), after the item of copy is selected and the item of basic cassette is selected, the set key 25 is operated in S6.

In the same way, when the item of receiving mode is to be allocated to the one-touch key 22 of key No. (3), after FAX which is a first stage menu is selected and the item of receiving mode which is a second stage menu is further selected, the set key 25 is operated in S6.

Further, when the processing of key allocation is completed, the menu key 23 is operated again.

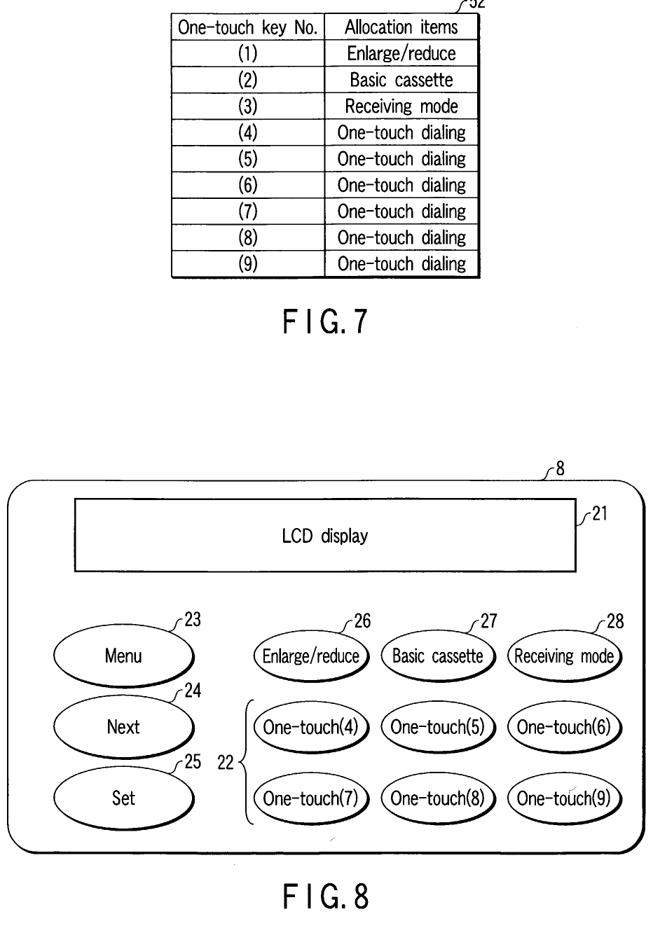

By carrying out such key allocation processing, the contents of the second memory section 52 are switched from FIG. 4 to FIG. 7.

In other words, the allocated items of the one-touch keys 22 of keys Nos. (1) to (3) of the second memory section 52 are switched from the item of one-touch dialing to the items of enlarge/reduce, basic cassette, and receiving mode.

In the operating section 8, as shown in FIG. 8, the one-touch keys 22 of keys Nos. (1) to (3) for reading the telephone numbers of other parties by one-touch operation are respectively switched to short-cut keys 26, 27, 28 for reading the items of enlarge/reduce, basic cassette, and receiving mode.

In this way, the keys 22 set in advance as one-touch keys can be easily changed to the short-cut keys 26, 27, 28 for reading the functions of enlarge/reduce, basic cassette, and receiving mode.

Accordingly, the device is easy to use for a user frequently using enlargement/reduction of copies, setting of basic cassettes, and FAX communication.

The order of the menu items set in the first memory section 51 can be changed by key-operation of the operating section 8.

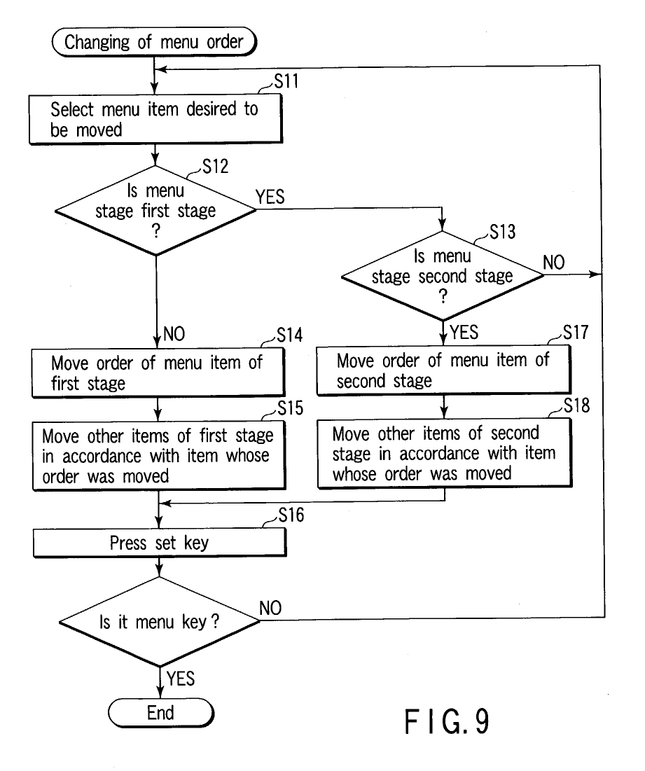

That is, the CPU 1 carries out the processing of changing the menu order shown in FIG. 9. The processing of changing the menu order is executed after the item of menu order is read from the first memory section 51 and displayed on the display 21 by operating the menu key 23, the NEXT key 24, and the set key 25.

In the processing of changing the menu order, first, in S11, the menu item desired to be moved is selected. Next, in S12 and S13, it is determined whether the selected menu is a first stage menu or a second stage menu or another.

When the selected menu is a first stage menu, the order of this first stage menu is moved in S14, and then, in S15, the items of the other first stage menus are moved in accordance with the item whose order was moved. In S16, the movements are set by pressing the set key 25. Note that a working memory having the same structure is used in the processing of changing the menu order.

Alternatively, when the selected menu is a second stage menu, the order of this second stage menu is moved at S17, and subsequently, in S18, the items of the other second stage menus are moved in accordance with the item whose order was moved. In S16, the movements are set by pressing the set key 25.

Finally, the processing of changing the menu order is completed by operating the menu key 23.

The one-touch keys 22 of keys Nos. (1) and (2) are set as the short-cut keys 26, 27 for directly reading the functions of enlarge/reduce and basic cassette.

In accordance therewith, even if the items of enlarge/reduce and basic cassette of copy are disposed at the end of the menu order, they can be immediately read by operations of the short-cut keys 26, 27.

The processing of changing the menu order shown in FIG. 9 is executed, and the items of copy, enlarge/reduce, and basic cassette are disposed at the end of the menu order, and the order of receiving mode and password communication of FAX are switched.

For this, first, the menu items desired to be moved are selected. That is, the items of copy, enlarge/reduce, basic cassette, receiving mode, and password communication are selected.

The following operations are carried out: copy is moved to the 12^{th} place in the menu order, and enlarge/reduce is moved to the 13^{th} place in the menu order, and basic cassette is moved to the 14^{th} place in the menu order, and receiving mode is moved to the 3^{rd} place in the menu order, and password communication is moved to the 2^{nd} place in the menu order.

In accordance therewith, the menu item of copy is read from the first memory section 51 and stored in the 12^{th} place in the menu order of the working memory.

Subsequently, the menu item of FAX is read from the first memory section 51 and stored in the 1^{st} place in the menu order of the working memory, and the menu item of registration is read from the first memory section 51 and stored in the 4^{th} place in the menu order of the working memory, and the menu item of list printing is read from the first memory section 51 and stored in the 9^{th} place in the menu order of the working memory.

Next, the menu item of enlarge/reduce is read from the first memory section 51 and stored in the 13^{th} place in the menu order of the working memory, and then, the menu item of basic cassette is read from the first memory section 51 and stored in the 14^{th} place in the menu order of the working memory.

Thereafter, the menu item of receiving mode is read from the first memory section 51 and stored in the 3^{rd} place in the menu order of the working memory, and then, the menu item of password communication is read from the first memory section 51 and stored in the 2^{nd} place in the menu order of the working memory.

Next, the menu item of one-touch dialing is read from the first memory section 51 and stored in the 5^{th} place in the menu order of the working memory, and then, the menu item of date is read from the first memory section 51 and stored in the 6^{th} place in the menu order of the working memory.

After that, the menu item of key allocation is read from the first memory section 51 and stored in the 7^{th} place in the menu order of the working memory, and then, the menu item of menu order is read from the first memory section 51 and stored in the 8^{th} place in the menu order of the working memory.

Then, the menu item of communication management is read from the first memory section 51 and stored in the 10^{th} place in the menu order of the working memory, and thereafter, the menu item of test printing is read from the first memory section 51 and stored in the 11^{th} place in the menu order of the working memory.

In this way, when storing of all of the menu items in the working memory is completed, the contents of the working memory are moved to the first memory section 51.

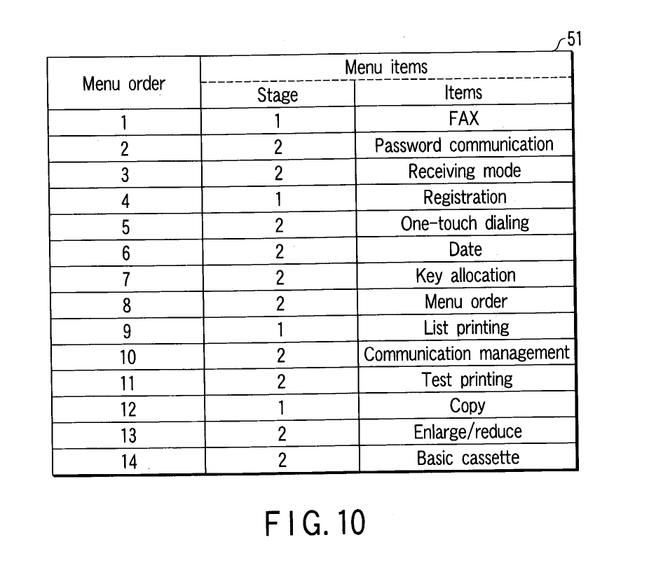

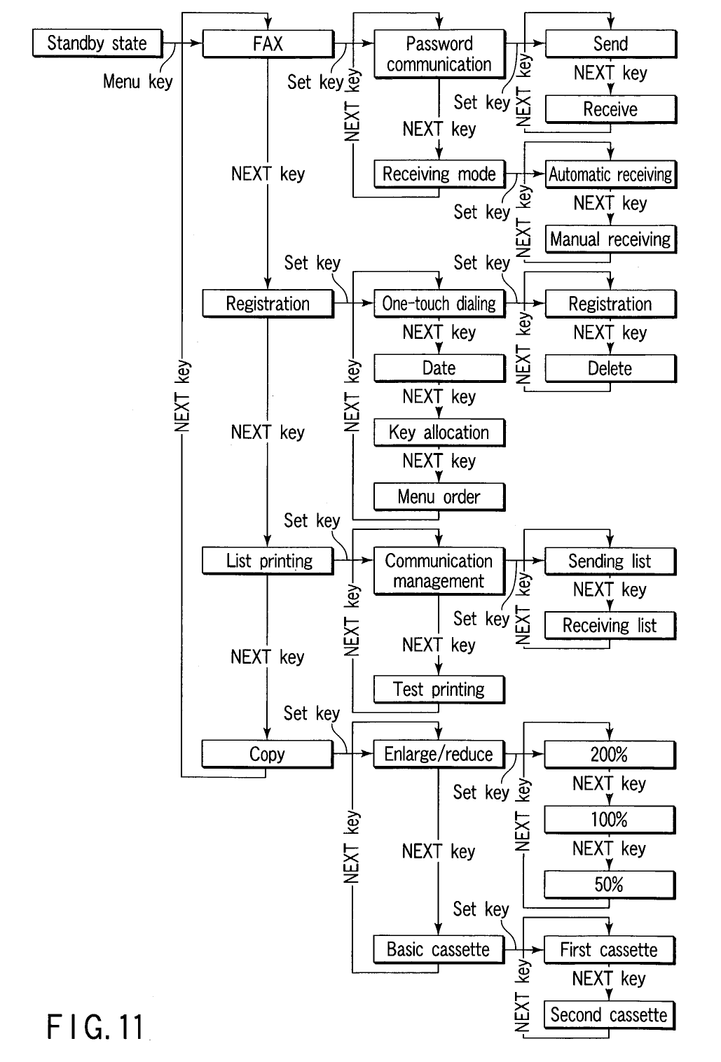

Thereby, the contents of the first memory section 51 are changed from FIG. 3 to FIG. 10. In other words, the orders of the menu items of copy, enlarge/reduce, basic cassette, receiving mode, and password communication is changed.

In accordance with this change, it takes much time to read the items of enlarge/reduce and basic cassette of copy by operating the menu key 23, the NEXT key 24, and the set key 25. However, there is no trouble because they can be easily read by the short-cut keys 26, 27.

Due to the menu order of the respective menu items stored in the first memory section 51 being changed in this way, the order of operations of reading the items from the first memory section 51 and displaying them on the display 21 by the operations of the menu key 23, the NEXT key 24, and the set key 25 is changed as shown in FIG. 11.

In this way, the menu order of the respective menu items stored in the first memory section 51 can be easily changed.

Although there are 14 types of menu items set in the first memory section 51, the number of types of menu items is not limited to the same. Further, although there are nine one-touch keys, the number of one-touch keys is not limited to the same.

Additional advantages and modifications will readily occur to those skilled in the art. Therefore, the invention in its broader aspects is not limited to the specific details and a representative embodiments shown and described herein. Accordingly, various modifications may be made without departing from the spirit or scope of the general inventive concept as defined by the appended claims and their equivalents.

What is claimed is:

1. An input unit comprising:
a display;
a first memory section in which various types of menu items to carry out operation start, setting, and key allocation of respective functions are set;
a key for reading which successively reads the various types of menu items set in the first memory section and displays the menu items on the display;
a plurality of keys to be set in which the various types of menu items set in the first memory section can be set as key functions;
a menu item allocating section which selects and operates one of the keys to be set in a state in which a menu item of key allocation is displayed on the display by the key for reading, and reads a menu item for which allocation is desired from the first memory section by the key for reading in this state, thereby allocating the menu item to said one of the keys to be set; and
a second memory section which stores the menu items allocated to the respective keys to be set.

2. An input unit according to claim 1, wherein said plurality of keys to be set initially function as one-touch keys for one-touch dialing to other parties of telephone numbers which are set.

3. An input unit according to claim 1, wherein a menu order of the various types of menu items set in the first memory section is set, and the menu items are successively read by the key for reading in accordance with the menu order.

4. An input unit according to claim 3, wherein, after the menu items are read by the key for reading, the menu order of the various types of menu items set in the first memory section changes the order of the menu items and makes it variable.

5. A method of allocating menu items for use in an input unit, comprising:
successively reading various types of menu items by a key for reading from a first memory section in which are set the various types of menu items to carry out operation start, setting, and key allocation of respective functions, and displaying the menu items on a display;
selecting and operating one of a plurality of keys to be set in which the various types of menu items set in the first memory section can be set as key functions; and
reading a menu item for which allocation is desired from the first memory section by the key for reading in the selected and operated state, and allocating the menu item to said one of the keys to be set.
